(19) United States
(12) Patent Application Publication
(10) Pub. No.: US 2011/0304913 A1
(43) Pub. Date: Dec. 15, 2011

(54) LIGHT INTENSIFYING DEVICE WITH POLARIZATION CONVERSION FUNCTION

(75) Inventor: PING-YANG CHUANG, Tu-Cheng (TW)

(73) Assignee: HON HAI PRECISION INDUSTRY CO., LTD., Tu-Cheng (TW)

(21) Appl. No.: 12/944,758

(22) Filed: Nov. 12, 2010

(30) Foreign Application Priority Data
Jun. 10, 2010 (TW) 99118852

(51) Int. Cl. G02B 5/30

(52) U.S. Cl. 359/489.08

(57) ABSTRACT

A light intensifying device with a polarization conversion function is provided. The light intensifying device includes a transparent mirror, a spectroscope, a reflective mirror, a light wave converter, and an optical fiber. The transparent mirror is aligned with a light source, and receives a light beam from the light source. The spectroscope receives the light beam transmitted from the transparent mirror, reflects a portion of the received light beam to form an S-polarized light beam and transmits the remained portion to form a P-polarized beam. The reflective mirror receives the S-polarized beam and reflects a S-polarized image to the lens module. The light wave converter receives the P-polarized beam, and converts the P-polarized beam to the S-polarized beam. The optical fiber is connected between the light wave converter and the transparent mirror, and transmits the converted S-polarized beam to the transparent mirror.

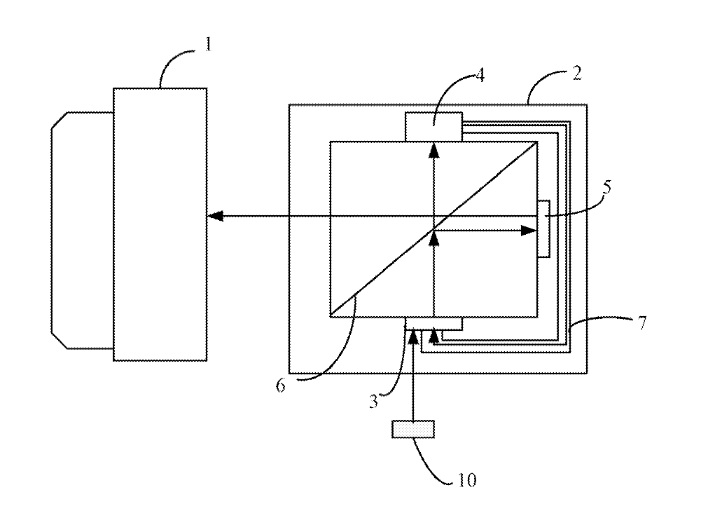

### BACKGROUND

1. Technical Field

The present disclosure relates to light intensifying devices and, particularly, to a light intensifying device with a polarization conversion function.

2. Description of Related Art

Projection device usually includes a polarizing beam splitter (PBS) which reflects a portion of a light beam to form an S-polarized beam and transmits the remaining portion to form a P-polarized beam. The S-polarized beam is usually reflected to a display such as liquid crystal on silicon (LCOS), and the display then reflects an S-polarized image to a lens module. The lens module projects the S-polarized image to a screen. The P-polarized beam is usually transmitted, and cannot been transmitted to the lens module, this results in a low brightness of the lens module.

### BRIEF DESCRIPTION OF THE DRAWINGS

The drawing is a schematic view of a light intensifying device with a polarization conversion function in accordance with an exemplary embodiment.

### DETAILED DESCRIPTION

Referring to the drawing, a light intensifying device 2 is illustrated, in accordance with an exemplary embodiment. The light intensifying device 2 receives light beam from a light source 10, and transmits the light beam to a lens module 1. In one embodiment, the light source 10 may be lasers or LEDs.

The light intensifying device 2 includes a transparent mirror 3, a spectroscope 6, a reflective mirror 5, a light wave converter 4, and an optical fiber 7.

The transparent mirror 3 is aligned with the light source 10, and receives the light beam from the light source 10 and transmits the received light beam.

The spectroscope 6 receives the light beam from the transparent mirror 3, reflects a portion of the received light beam to form a S-polarized beam, and transmits the remaining light beam to form a P-polarized beam. The transmission direction of the S-polarized beam is substantially perpendicular to that of the P-polarized beam and the light beam from the light source 10. In one embodiment, the spectroscope 6 may be a polarizing beam splitter (PBS), or a dichroic mirror.

The reflective mirror 5 is placed on a sidewall of the light intensifying device 2 away from the lens module 1, and receives the S-polarized beam and reflects a S-polarized image to the lens module 1. The lens module 1 projects the S-polarized image. In one embodiment, the reflective mirror 5 is a liquid crystal on silicon (LCOS). In other embodiment, the reflective mirror 5 may be a micro electro mechanical systems (MEMS) reflective mirror.

The light wave converter 4 is placed opposing the transparent mirror 3, and receives the P-polarized beam and converts the P-polarized beam to the S-polarized beam.

The optical fiber 7 is connected between the light wave converter 4 and the transparent mirror 3, and transmits the converted S-polarized beam to the transparent mirror 3.

The transparent mirror 3 further transmits the converted S-polarized beam to the spectroscope 6. The spectroscope 6 reflects the S-polarized beam to the reflective mirror 5. The reflective mirror 5 receives the S-polarized beam and reflects the S-polarized image to the lens module 1, thereby enhancing light utilization efficiency.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A light intensifying device with a polarization conversion function, and used for transmitting a light beam from a light source to a lens module, the light intensifying device comprising:
a transparent mirror to be aligned with the light source, and configured for receiving the light beam from the light source and transmitting the received light beam;
a spectroscope configured for receiving the light beam from the transparent mirror, reflecting a portion of the received light beam to form a S-polarized beam and transmitting the remained portion to form a P-polarized beam;
a reflective mirror to receive a S-polarized beam from the spectroscope and reflect a S-polarized image to the lens module;
a light wave converter to receive the P-polarized beam, and convert the P-polarized beam to a S-polarized beam; and
an optical fiber connected between the light wave converter and the transparent mirror, and configured for transmitting the converted S-polarized beam to the transparent mirror, wherein transparent mirror further transmits the converted S-polarized beam to the spectroscope.

2. The light intensifying device as described in claim 1, wherein the spectroscope is a polarizing beam splitter.

3. The light intensifying device as described in claim 1, wherein the spectroscope is a dichroic mirror.

4. The light intensifying device as described in claim 1, wherein the reflective mirror is a liquid crystal on silicon.

5. The light intensifying device as described in claim 1, wherein the reflective mirror is a micro electro mechanical systems reflective mirror.

6. The light intensifying device as described in claim 1, wherein the light wave converter is placed opposing the transparent mirror.
